(19) United States
(12) Patent Application Publication
(10) Pub. No.: US 2008/0162589 A1
(43) Pub. Date: Jul. 3, 2008

(54) WEAKLY-CONSISTENT DISTRIBUTED COLLECTION COMPROMISED REPLICA RECOVERY

(75) Inventors: Thomas L. Rodeheffer, Mountain View, CA (US); Edward P. Wobber, Menlo Park, CA (US); Douglas Terry, San Carlos, CA (US); Venugopalan Ramasubramanian Saraswati, Mountain View, CA (US)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 11/618,090

(22) Filed: Dec. 29, 2006

(51) Int. Cl. G06F 17/30; G06F 12/00; G06F 17/00

(52) U.S. Cl. 707/202; 707/204; 707/203; 707/E17.007; 707/E17.01; 707/E17.001

(57) ABSTRACT

A system is disclosed for recovery from a compromise of a replica in a weakly-consistent distributed collection. The system employs a collection manager for revoking a compromised replica, and one or more archival replicas for storing time-stamped versions. Upon a compromise, versions tainted by the compromised replica may be expunged from the collection. Thereafter, versions determined to be unaffected by the compromise may be returned to the collection using the time-stamped versions stored in the one or more archival replicas.

### BACKGROUND

In a system of computing devices, an object may be multiply replicated to create a number of copies of the object on the different computing devices and/or possibly within a single device. An object may be any stored item, such as for example contact or calendar information, stored pictures or music files, software application programs, files or routines, etc. The system of computing devices may for example be a desktop computer, a remote central server, a personal digital assistant (PDA), a cellular telephone, etc. The group of all such objects and replicas where the objects are stored may be referred to as a distributed collection.

It is known for the different computing devices to communicate with each other to synchronize the multiple replicas of an object using various synchronization and conflict resolution protocols. Synchronization protocols are the means by which replicas exchange created and updated versions of objects in order to bring themselves into a mutually consistent state. The periodicity of the sync may vary greatly. Networked devices may sync with each other frequently, such as once every minute, hour, day, etc. Alternatively, devices may sync infrequently, such as for example where a portable computing device is remote and disconnected from a network for a longer period of time. Whether the synchronization is frequent or infrequent, the distributed collection is said to be weakly-consistent in that, in any given instant, there may not be a single, cohesive view of the collection of objects.

FIG. 1 illustrates a known weakly-consistent distributed collection, including multiple replicas 20, arbitrarily referred to as replicas P through T. The number of replicas is by way of example and may be more or less than shown. Each replica 20 may be a computing device including a data store and associated processor. However, as is known, a single computing device may include several replicas, and a single replica may be spread across more than one computing device. The replicas 20 may synchronize (or be synchronized) with each other from time to time, for example via a peer-to-peer network 22.

Each replica 20 may create a new version of an object, either when it creates the first version of a new object, or when it updates an existing version of an object to create a new version of the object. In order to keep track of the different versions of objects synched between the replicas, each version of an object may have an associated version vector. A version vector is a data structure stored in association with each version of an object in a replica summarizing the history of updates which generated the current version. For example, in prior art FIG. 2, replica P creates the first version of a new object at time 1. In this example, versions are arbitrarily identified by their replica and time, so the version created by P at t1 is P1. P1's version vector is:

[P→1, Q→0, R→0, S→0, T→0].

In many cases, a version vector maps a replica to the number zero (as in replicas Q, R, S and T in the above example), so typically this case is assumed as the default and not represented explicitly. Thus, version P1 may be represented by the version vector: [P→1].

When a replica, for example replica R, receives and updates P1 to a new version, a new version vector may be created for the new version by copying values from the old version vector, except for the value mapped from the creating/updating replica itself, which is increased. Thus, in the example of FIG. 2, replica R receives the version P1 and, at time 2, makes changes to it which results in version R2. The version vector for R2 is:

[P→1, R→1].

Replica R makes further changes to the object at t4 to create version R4. The version vector for R4 is:

[P→1, R→2].

Replica S receives the version R4 and, at time 5, updates it to version S5. The version vector for S5 is:

[P→1, R→2, S→1].

Version vectors may be used to distinguish among the different versions of the same object in order to determine whether a given version supersedes or is in conflict with another version. A first version vector supersedes a second version vector if: (1) for each replica, the first version vector maps to a number that is no less than the number mapped to by the second version vector; and (2) for some replica, the first version vector maps to a number that exceeds that mapped to by the second version vector. Two distinct version vectors, where neither supersedes the other, are said to be in conflict. Under conventional practice, a superseded version may be discarded from a replica data store, while versions which are in conflict are maintained until the conflict is resolved (for example manually by a user or by a conflict resolution protocol).

Thus, in the example of FIG. 2, version P1 is superseded by version R2, R2 is superseded by version R4, and R4 is superseded by version S5. However, in comparing for example version Q3 [P→2, Q→1] with version R4 [P→1, R→2], by the above rule, neither version supersedes the other, and the two versions would be in conflict and both maintained.

As indicated, a version may represent an update to an object or creation of a new object. A different set of version vectors may be stored for each object. Thus, in FIG. 2, replica P creates a brand new object at time 4 called P4. As a new object, its version vector again may again be [P→1]. Q receives the new object and at time 5, updates the new object to version Q5 having version vector [P→1, Q→1]. Version vectors for different objects are not compared against each other.

As indicated, from time to time, a first replica synchronizes with a second replica, causing the second replica to learn the versions known by the first replica. By repeating the synchronization process between replicas, all replicas eventually learn about the most up to date versions of each object.

Security is an important concern in maintaining the integrity of a user's information. A cell phone or other computing device may be lost, stolen or otherwise accessed by an unauthorized user, at which time the unauthorized user can compromise a replica by introducing bogus changes to a user's stored objects and/or create bogus new objects. Security measures, such as public key cryptography, may be employed to ensure that only authorized replicas be allowed to create a version. However, it is possible that the private key of the key pair can be obtained when the replica is compromised by the unauthorized user. Worse still is that the unauthorized access may not be detected until some time after the compromise, during which interim the bogus changes may have been synched to the other replicas, possibly causing good versions to be superseded by bogus versions.

This scenario is illustrated in prior art FIG. 3. At time 1, replica P creates a new object as version P1 and replica R creates a new object as version R1. Replica Q learns about R1 and at time 2 updates it to Q2. Replica R learns about Q2 and at time 3 updates it to R3. Meanwhile, at time 2 replica P creates a new object as version P2, replica Q learns about it and at time 3 updates it to Q3, then replica R learns about this and at time 5 updates it to R5. At time 5 replica P creates a new object as version P5.

At some point in time after time 6, it is determined that replica Q was compromised at time 4 and at time 5 the compromised replica Q creates a bogus new object as version Q5. Replica R learns of version Q5 and at time 6 updates it to version R6. Replica Q learns of P5 and at time 6 updates it to version Q6.

The unauthorized user created new objects as versions Q5 and Q6, which are assumed to be bogus. Q6 supersedes P5. If enough time has elapsed for the synchronization process to spread Q6 around, the replicas will have discarded P5 from their stores. Replica R updated the bogus version Q5 to create version R6. It should be assumed that Q5 influenced R6, and that R6 is bogus as well. Thus, it can be seen that the compromise of a replica discovered some time after the compromise can result in two problems: the introduction of bogus versions which are propagated to other replicas through the sync process; and the discarding of good versions as a result of being superseded by bogus versions.

At present, there is a need for an effective system for dealing with the compromise of a replica, and for recovery from a compromised replica, in a weakly-consistent distributed system.

### SUMMARY

The present technology, roughly described, relates to a system for recovery from a compromise of a replica in a weakly-consistent distributed collection. The system includes a plurality of replicas capable of creating and/or updating versions of an object in a collection. Each created/updated version may have an associated version vector, from which a replica may discern various characteristics of a version, including which replicas created/updated the version. One or more of the replicas may also be an archival replica. These function similarly to other replicas, but further persistently store all versions received in the archival replica with a time-stamp indicating when the versions were stored.

A collection manager is additionally provided to ensure that only authorized replicas create or update versions in the collection. In embodiments, the collection manager may implement an authorization protocol over the collection. In particular, replicas are authorized by statements (certificates) signed by a cryptographic key known only to the collection manager. These authorization statements define the policy of the collection. Authorization policy statements can be signed with public-key cryptography, or with shared-key cryptography via a trusted third party. The discussion below assumes public key cryptography for exemplary purposes.

Each replica includes public and private key pairs. Each replica may be identified by a public part of a key pair for which it maintains the private part of the key pair. When a replica creates/updates a version, it signs the version with its private key. Upon receipt of a version through the synch process, a replica checks that the signature on the received version is valid, and that the signing replica is authorized to make the signature (as described above).

Upon receiving an indication that a given replica was compromised, the collection manager may revoke the compromised key, thus removing the compromised replica from the collection. The collection manager can also send a message to the replicas to expunge tainted versions from their stores. Tainted versions are those that were influenced (created or updated) by a compromised replica. Each replica may include a taint mechanism for removing tainted versions from its data store upon notification of a compromised replica from the collection manager.

Expunging all tainted versions, regardless of when they were created or updated by the compromised replica, may result in an “excessive taint” situation. This is because certain versions are removed as being tainted, even though they can be positively identified as being created or influenced by the compromised replica before the compromise occurred. Such versions, referred to herein as “innocent versions,” could not have been affected by the unauthorized user.

In accordance with a further aspect of the present system, innocent versions are recovered and returned to the collection. Similarly, reliable versions which were superseded by an expunged bogus version are also recovered and returned to replica data stores. The present system makes use of the archival replicas to allow the recovery and return of expunged versions to replicas in a collection. An archival replica includes a clock indicating the current time and a time-stamped archive that records every version ever seen by the archival replica. A recording mechanism is provided for recording versions from the archival replica data store into the archive. The archival replica may further include a recovery mechanism. The recovery mechanism is provided for performing a rewrite process to remove a taint from innocent versions and a restore process that restores discarded versions from the archive to the store.

When the collection manager revokes a replica private key, it may then create and authorize a new key to replace the compromised key. This new key represents a newly created virtual replica that will be used to replace the compromised replica. In operation, the rewrite process examines whether versions stored in the archive were created or influenced by the compromised replica before the compromise occurred. If such an innocent version is found, the rewrite process rewrites the version vector associated with that innocent version to remove reference to the compromised replica, and replace that with reference to the virtual replica. After the rewrite process, the version vectors for innocent versions no longer reflect the taint by the revoked replica, and the restore mechanism may then return those versions to the collection.

The present system can employ one or more archival replicas. Multiple archives benefit from the fact that no communication is needed between archives other than that performed by the normal synchronization between replicas. Because of synchronization delays, the various archives may not each have seen all versions ever created, so when the archives independently recover versions according to their own information, some of the recovered versions may supersede others and some may be in conflict. No additional mechanism is needed to resolve this situation. The present system exploits the ordinary synchronization process to resolve recovered versions in the same way that the original versions were or would have been resolved.

### BRIEF DESCRIPTION OF THE DRAWINGS

FIG. 1 is weakly-consistent distributed collection according to the prior art.

FIG. 2 is an example timeline of versions of objects from replicas within the collection of prior art FIG. 1.

FIG. 3 is an example timeline of versions of objects from replicas within the collection of prior art FIG. 1, where replica Q is compromised at time 4.

FIG. 4 is weakly-consistent distributed collection according to an embodiment of the present system.

FIG. 5 is a block diagram of a pair of replicas and the collection manager from the weakly-consistent distributed collection of FIG. 4.

FIG. 6 is a flowchart of the operation and interaction of the collection manager and replicas to implement a secure exchange of versions according to an embodiment of the present system.

FIG. 7 is a flowchart of the operation of the collection manager upon receiving indication of a compromised replica according to an embodiment of the present system.

FIG. 8 is an example timeline of versions of objects from replicas within the collection of FIG. 4, where replica Q is compromised at time 4.

FIG. 9 is a block diagram of a sample replica from the weakly-consistent distributed collection of FIG. 4 including a taint mechanism according to an embodiment of the present system.

FIG. 10 is a flowchart of the operation of a taint mechanism associated with a replica according to an embodiment of the present system.

FIG. 11 is a block diagram of a sample archival replica according to an embodiment of the weakly-consistent distributed collection of FIG. 4.

FIG. 12 is a flowchart showing the recording of records from a replica data store into the archival replica according to an embodiment of the present system.

FIG. 13 is a flowchart showing the rewriting process for rewriting innocent versions to remove their taint according to an embodiment of the present system.

FIG. 14 is a flowchart showing the restore process for restoring versions from the archive to the data store within an archival replica according to an embodiment of the present system.

FIG. 15 is an example timeline of versions of objects from replicas within a collection, where replicas U and V are compromised at time 5 and 4, respectively.

FIG. 16 is a block diagram of a computing system environment according to an embodiment of the present system.

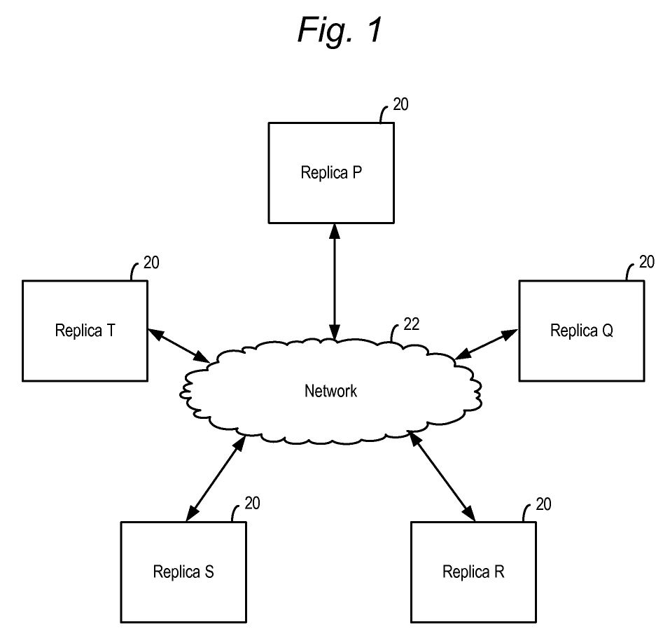

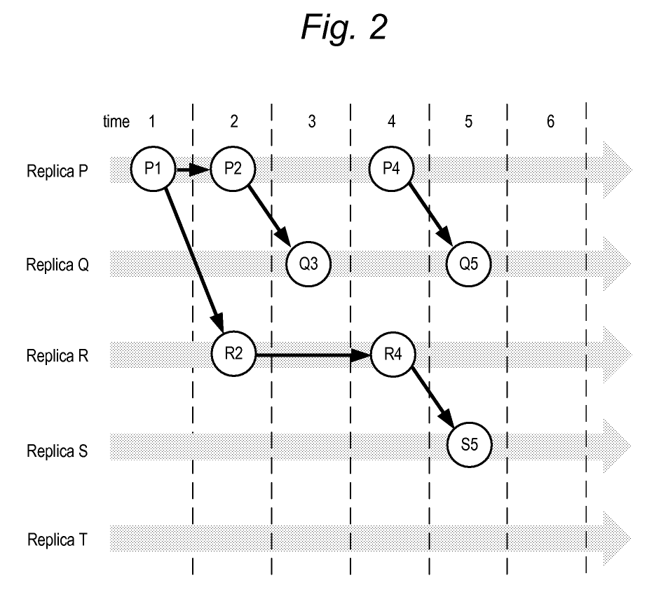

### DETAILED DESCRIPTION

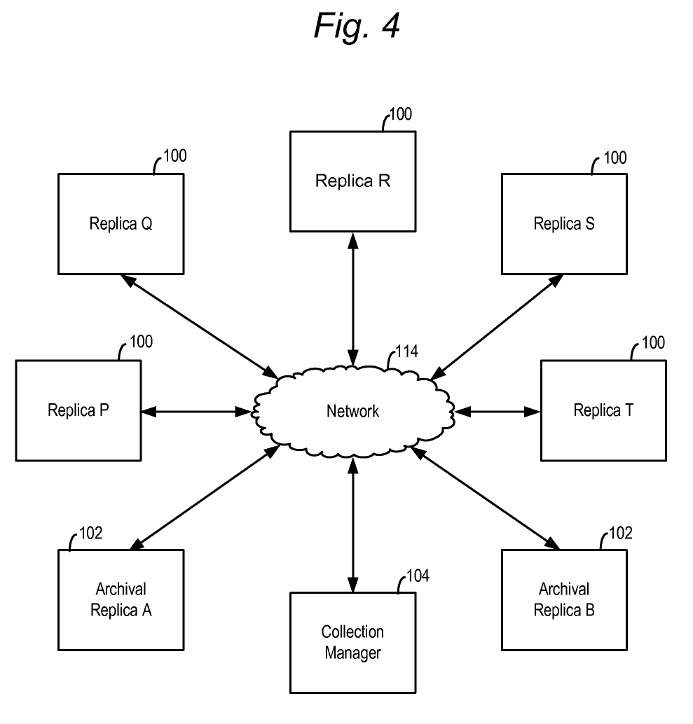

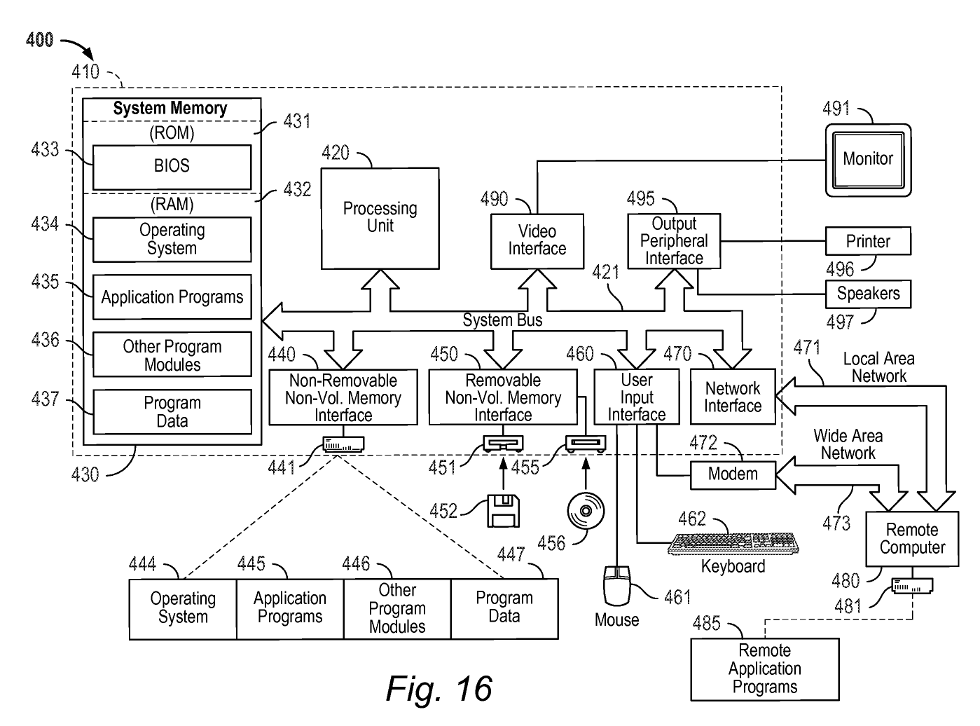

The present system will now be described with reference to FIGS. 4-16, which in general relate to a system for recovering from a compromised replica in a weakly-consistent distributed collection. The system may be implemented on a distributed computing environment, including for example one or more desktop personal computers, laptops, handheld computers, personal digital assistants (PDAs), cellular telephones, multiprocessor systems, microprocessor-based systems, programmable consumer electronics, minicomputers, and/or other such computing system environments. Details relating to one such computing system environment are explained hereinafter with respect to FIG. 16. Two or more of the computing system environments may be continuously and/or intermittently connected to each other via a network such as peer-to-peer or other type of network as is known in the art.

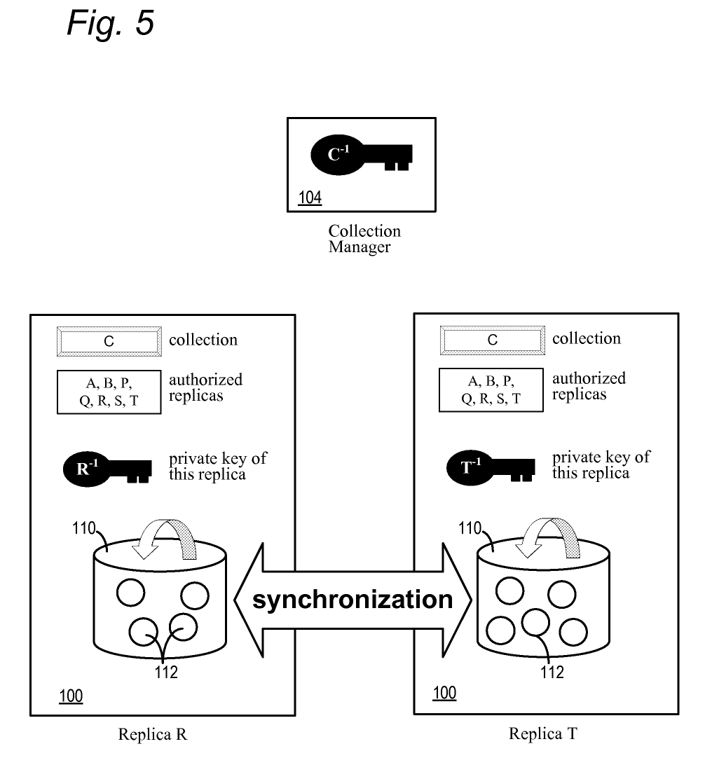

Referring initially to FIGS. 4 and 5, the system includes a plurality of replicas 100, arbitrarily referred to herein as replicas P through T. Each replica 100 may create and/or modify a version of an object in a collection. As used herein, a replica that creates and/or modifies a version is said to have “influenced” that version. Each influenced version may have an associated influence list, which may be a version vector, from which a replica may determine the history of influencing replicas, whether a given version supersedes another version or whether a given version is in conflict with another version. A replica may be a computing system environment. However, as explained hereinafter, each replica may be designated by a public-private key pair, and accordingly, multiple replicas may exist on a single computing system environment, and a single replica may exist across multiple computing system environments. As indicated in FIG. 5, each replica 100 may include a data store 110 associated with a processor on one or more computing system environments mentioned above or as known in the art. The processor can place versions 112 into data store 110 and can expunge versions 112 from data store 110. The number of replicas comprising the collection shown in the figures is by way of example and there may be greater or fewer replicas in the collection than is shown.

As is known in the art, each replica is capable of synchronizing with each other replica via a network 114, which may be the Internet, a LAN, a WLAN or any of a variety of other networks. As is known, the sync process may be carried out through a central server or peer-to-peer connection. When a version is created or updated by a replica, the sync process propagates that version across all replicas over time. If a first version is updated to a second version by a replica, then to the extent the first version exists on other replicas, it will be superseded and replaced by the second version on the other replicas as those replicas sync. Thus, over time, each replica will contain the most current version of an object. Where two versions are in conflict with each other, both conflicting versions will exist on the replicas until resolved.

Referring again to FIG. 4, the system further includes archival replicas 102, arbitrarily referred to as archival replicas A and B. Although two are shown, there may be one or more than two in alternative embodiments. The archival replicas may be replicas in the same sense as replicas P through T, but perform additional time-stamped archival functions as explained hereinafter.

The system needs safeguards in place to ensure that only authorized replicas can create or update versions in the collection. The collection manager 104 is provided for the purpose of issuing authorization policy. In embodiments, the collection manager 104 may be a computing system environment capable of issuing policy statements during the normal operation of the system. Other protocols, such as those using shared key cryptography are contemplated. In embodiments, the collection manager 104 may be a replica, or operate in association with a particular replica. The collection manager may be part of the synched network of the collection. Alternatively, the collection manager may be completely or primarily offline. For example, the collection manager may be represented by a public key stored on a portable storage device kept in a physical safe. In this case, the portable storage device would be brought out to sign statements when necessary, but otherwise kept offline to avoid compromise.

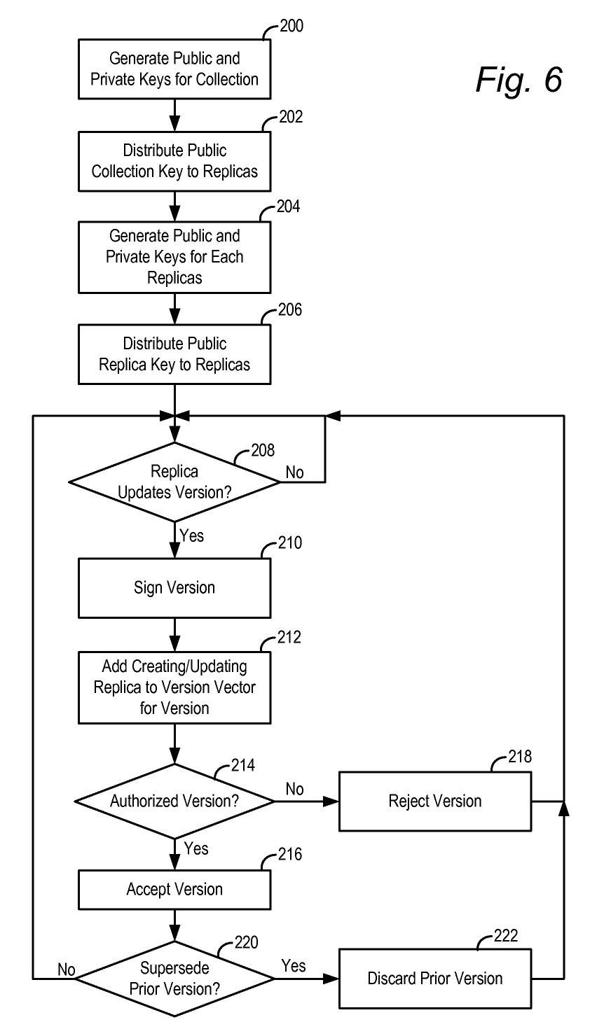

Operation and interaction of the collection manager and replicas to implement a secure exchange of versions is now explained with reference to the flowchart of FIG. 6. Where the collection manager 104 operates using public key cryptography, a public and private key pair, arbitrarily referred to herein as C and C⁻¹, are generated for or by the collection manager in step 200. The collection public and private key pair is used to authorize all replicas in the collection. The collection manager 104 stores the private key C⁻¹, and distributes the public key C to all replicas within the collection in step 202. Replicas are authorized by statements (certificates) signed by the private key C⁻¹. These authorization statements define the policy of the collection. As indicated above, authorization policy statements can be signed with public-key cryptography, or with shared-key cryptography via a trusted third party.

Replica public and private key pairs are generated for or by each replica 100, 102 in step 204. Each replica in the collection is identified by its own public key which is distributed to the collection in step 206. Each replica maintains its corresponding private key. Thus, each replica knows the public key of the collection and the public keys of all authorized replicas. Each replica also knows its own private key.

In operation, when a first replica creates/updates a new version (step 208), the replica adds itself to the influence list associated with the new version, said influence list identifying replicas which influenced the new version (step 210). Preferably, the version vector may be used to implement the influence list, as explained hereinafter. The creating/updating replica signs the new version, via algorithms known in the art, using its private key in step 212. Upon receipt of the version in a second replica, the second replica performs three checks in step 214 to determine whether or not the new version is an authorized version.

First, the receiving replica checks that the signer is authorized by collection public key C. Second, once it is determined that the signing replica is authorized within the collection, the receiving replica checks that the signing replica's signature is correct, i.e., using the known signing replica's public key, the private key signature of the signing replica is validated. Third, the receiving replica checks that the influence list indicates that the signing replica influenced the new version. If all three checks are successful, the received version is deemed to be authorized, and the version is accepted by the second replica in step 216. Otherwise, the version is rejected in step 218. If accepted, the replica checks the influence list of the new version in step 220 to see if it supersedes an existing version in the store. If so, the superseded version may be discarded in step 222.

The collection manager 104 and replicas 100, 102 may use protocols other than public key cryptography in alternative embodiments to implement the above authorization procedure. As indicated, the collection manager 104 may comprise components in addition to a computing system environment in alternative embodiments for implementing an authentication protocol. In particular, the collection manager may be any device and/or entity capable of implementing the above procedure for authenticating versions circulated within the collection.

As explained in the Background section, replicas or even the collection manager may at times be compromised. Where the collection manager is compromised, it may be necessary to create an entirely new collection with new replicas and restore all the items from a backup made prior to the compromise. However, compromise of the private key of a replica 100 or 102 by an unauthorized user is less dire. In the compromised-replica case, once the compromise is recognized, the collection manager may revoke the compromised key, thus removing the compromised replica from the collection, and the collection could continue with the surviving replicas. This is less disruptive than creating a new collection with new replicas from backup.

Those of skill in the art would understand various methods of alerting the collection manager of the compromise, and causing the collection manager to revoke the compromised key. For example, in an embodiment, the collection manager may be a computing system environment, and a user may authenticate him or herself to the system by entering the private key for the collection manager into the system. Thereafter, the user can run a program on the system revoking a specified replica key and associated replica. Alternatively, the collection manager may be a hosted service. Upon identification of a compromised key, a user may contact the service, go through a security identification process, and then indicate which replica key and replica is to be revoked. The replica is then revoked by the service.

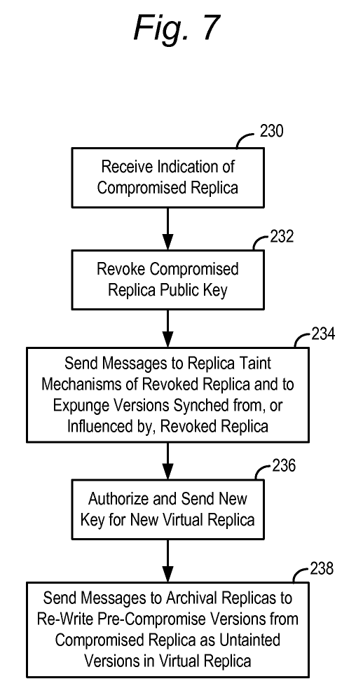

FIG. 7 is a flowchart of the operation of the collection manager upon receiving notification of a compromise. In step 230, the collection manager may receive indication of a compromised replica. The indication mechanism will provide the replica that was compromised and an earliest bound on the time at which the compromise occurred, as observed by a clock of the collection manager. It is noted that it is not imperative for the precise time of the compromise to be known or indicated by the detection mechanism. For example, there may be a time period bounded by an earliest and latest known time during which a replica was compromised. Selecting the earliest possible time within that bounded period removes any risk that tainted and bogus versions will be restored as good versions, but also may result in the greatest loss of versions. By contrast, selection of a latest possible time period will result in restoring the greatest number of versions, but runs the greatest risk of recapture of bogus versions created or updated by the unauthorized user.

After receipt of a compromise indication in step 230, the collection manager revokes the public key of the compromised replica in step 232. In step 234, the collection manager can send an indication to the replicas 100, 102 that the compromised replica has been revoked in a message signed with the private collection key. In step 234, the collection manager can also send a message to the replicas to expunge tainted versions from their stores. As explained hereinafter, tainted versions are those that were influenced by a compromised replica.

The above process may result in an “excessive taint” situation, where certain versions are removed as being tainted, even though they can be positively identified as being valid versions unaffected by the unauthorized user. Accordingly, in step 236, the collection manager can create and send to each archival replicas 102 a new key pair for a new replica, referred to herein as a virtual replica, to substitute for the compromised replica. In step 238, the collection manager may further send an indication to the archival replicas 102 to rewrite innocent versions from the compromised replica to the virtual replica. The rewriting process of steps 236 and 238 are explained in greater detail hereinafter. Those of skill in the art would appreciate that the authority to authorize and revoke replicas and to issue rewrite instructions may be performed by intermediaries authorized by the collection manager, or include intermediaries between the collection manager and the archival replicas.

As indicated above, upon identification of a compromise, the collection manager may send an indication to each replica to remove versions which may be tainted by the compromise from their data stores. Each replica may include a taint mechanism for identifying and removing versions from their data store originating from or influenced by a compromised replica. The taint mechanism may be software instructions executable by a processor associated with one or more replicas. Upon execution, the taint mechanism associated with a given replica checks to see whether any versions then in the data store of that replica are tainted, i.e., influenced by a compromised replica. That is, a version on a given replica will be considered tainted if it was created in the compromised replica and was added to the data store of the given replica through the sync process. A version on a given replica will also be considered tainted if, at any time in its history, it was updated by a replica that has been found to be compromised. Once the taint mechanism identifies a tainted version in a replica, the tainted version is expunged from the replica.

The taint mechanism may identify tainted versions by storing in association with a given version a list of all replicas that influenced it. Preferably, the version vector for the given version is used to indicate the influence list. However, those of skill would appreciate other methods of indicating a list of replicas that influenced that version. In order to ensure an accurate record of which replicas influenced a version, when a replica creates or updates a version, the taint mechanism updates the version vector (or other indicator) stored in association with that version with the identity of the creating or updating replica (step 210, FIG. 6). To establish the association between the version vector (or other indicator) and the version contents, the creating/updating replica uses its private key to generate a signature that covers both the version vector (or other indicator) and the version contents (step 212, FIG. 6).

In an alternate embodiment, in which the influence list is stored separately from the version vector, a replica may be permitted to update a version and claim that all prior influence should be disregarded. For example, if the update writes the entire contents of the new version from some trusted source, then perhaps no prior update should be considered as having any influence. In such a case, replicas may be removed from the influence list. However, the updating replica must always be included in the influence list.

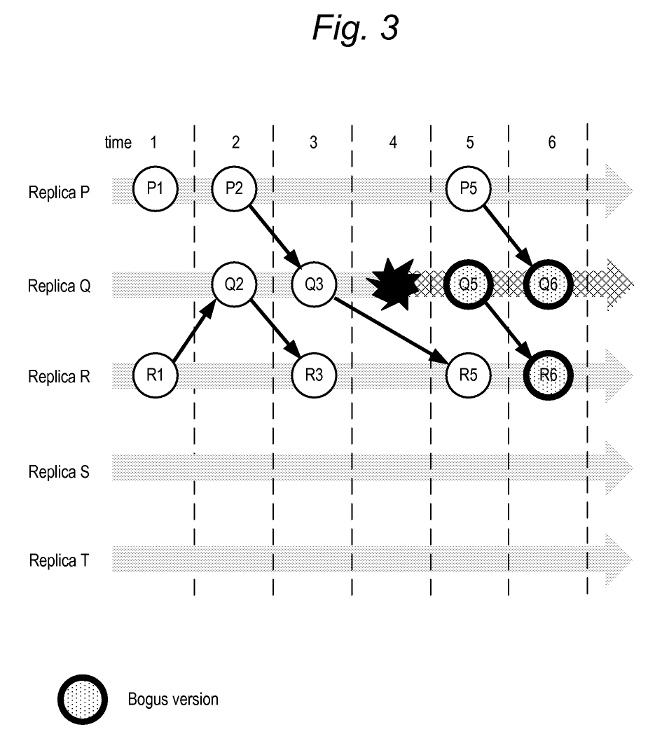

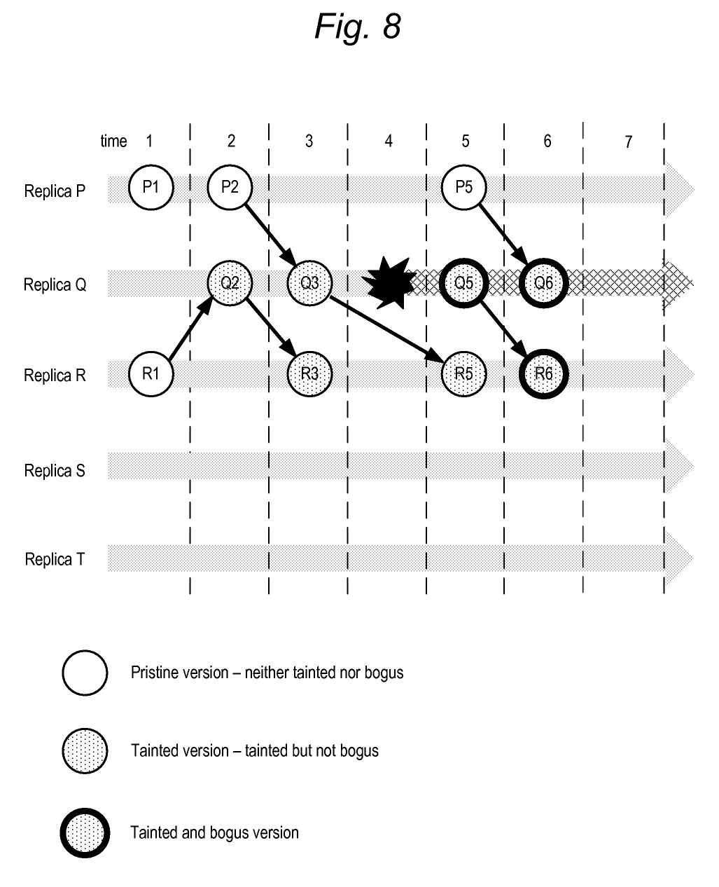

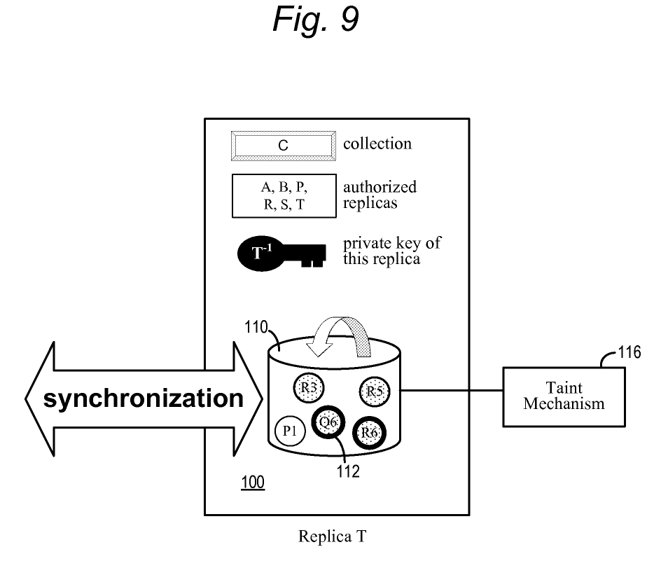

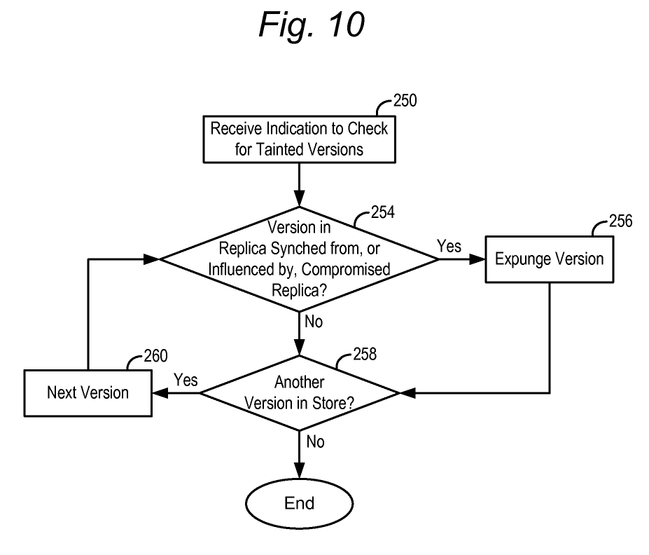

In embodiments, the taint mechanism for a given replica checks for tainted versions when some formerly authorized replica is revoked. In particular, there may be versions in the replica store influenced by the formerly authorized replica that are now considered as tainted and need to be discarded. An example of the operation of taint mechanism 116 is explained in greater detail with reference to FIGS. 8 and 9, and the flowchart of FIG. 10. FIG. 8 illustrates a time line of the same collection of replicas shown in prior art FIG. 3. FIG. 8 includes pristine versions (P1, P2, P5 and R1) which are not tainted by the compromised replica. There are versions which are tainted because they were influenced by the compromised replica, and hence the versions could not be falsified or affected by the unauthorized user. These tainted versions are called innocent (Q2, Q3, R3, R5). And there are tainted versions that were influenced by the compromised replica after the compromise (Q5 and Q6), and versions updated from those tainted versions (R6). These tainted versions could have been affected by the unauthorized user and should be considered bogus.

FIG. 9 is a snapshot of one of the replicas, replica T in this example, showing the stored versions of objects in the replica at time 7, given the creation and update of objects shown in FIG. 8. It is assumed that enough time has passed that the creation and update of all of the versions shown in FIG. 8 has been synched to replica T. Accordingly, replica T in FIG. 9 includes version P1 (which was created and then never updated), version R3 (which superseded versions Q2 and R1), version R5 (which superseded versions Q3 and P2), version Q6 (which superseded version P5), and version R6 (which superseded version Q5). Superseded versions may be discarded from the store. As indicated, the version vector associated with each version may be used by a replica to determine whether a given version is superseded by another version.

Referring now to FIGS. 8 and 9 and the flowchart of FIG. 10, the collection manager 104 received an indication that the private key of replica Q was compromised at time 4. The compromise was identified sometime after time 4, for example at time 7. As indicated above, the collection manager will revoke the public key for replica Q and send an indication to the replicas to remove versions which may have been tainted by the compromised replica Q. The operation of the taint mechanism for one replica, replica T, is explained below. The same explanation would apply to other replicas in the collection.

Taint mechanism 116 associated with replica T receives indication from the collection manager of the compromised replica in step 250. Once replica Q is compromised, all versions in replica T which were influenced by replica Q are assumed to be tainted and are also expunged. Accordingly, in step 254, the taint mechanism checks a first version in replica T for a taint by a compromised replica. As indicated, this may be done by checking the version vector or other indicator associated with a version. If the version was influenced by a compromised replica, the taint mechanism will indicate that the version is tainted, and the version is expunged from replica T in step 256. If not tainted it is left in the store. The taint mechanism next checks whether there are any additional versions in the replica in step 258. If there are, the taint mechanism retrieves that version (step 260) and again performs step 256 of checking the version for a taint.

In the present example, version Q6 was influenced by the compromised replica Q. Accordingly, Q6 will be expunged by the above process. Similarly, versions R3, R5 and R6 from replica R are tainted because they derive from versions Q2, Q3 and Q5, respectively. As such, versions R3, R5 and R6 are also expunged from replica T. Thus, after the taint engine expunges tainted versions from replica T at time 7, all that remains in replica T at time 7 is version P1. The other replicas go through similar processes to expunge any tainted versions.

After a compromise is identified and the compromised replica removed from the collection, the above-described process may be carried out by a taint mechanism in each remaining replica in the collection to expunge any tainted versions. As the system is weakly consistent, the versions which exist in the other replicas may or may not be the same as in replica T.

The above-described process results in the removal of all tainted records from replica data stores in a collection. However, such a process may result in an excessive taint situation, in that innocent versions are tainted and as such are removed, even though they could not have been affected by the unauthorized user. For example, versions Q2 and Q3 may be considered tainted under the present system for being influenced by the compromised replica. However, they existed prior to the compromise and could not have been falsified by the unauthorized user. Similarly, versions R3 and R5 are updates of Q2 and Q3, and are also not bogus. Note this is true of R5 even though R5 occurred after the time of the compromise. This is so because nothing replica Q did after the compromise could have affected R5.

In accordance with a further aspect of the present system, innocent versions are recovered and returned to the data store of replicas. Similarly, reliable (pristine or innocent) versions which were superseded by an expunged bogus version are also recovered and returned to the data store of the replicas. The operations for recovering these versions are explained in greater detail below.

The present system makes use of the archival replicas 102 to allow the recovery and return of expunged versions to the replicas in a collection. An archival replica performs all the functions of an ordinary replica, storing versions and synchronizing with other replicas. In addition, an archival replica maintains a permanent time-stamped archive of versions seen by the replica. In alternative embodiments, the archive can occasionally or periodically truncate its log of version updates. In such embodiments, the recovery process, explained hereinafter, would not recover versions which have been truncated from the archive.

The present system can employ one or more archival replicas. Multiple archives benefit from the fact that no communication is needed between archives other than that performed by the normal synchronization between replicas. Because of synchronization delays, the various archives may not each have seen all versions ever created, so when the archives independently recover versions according to their own information (as explained below), some of the recovered versions may supersede others and some may be in conflict. No additional mechanism is needed to resolve this situation. The present system exploits the ordinary synchronization process to resolve recovered versions in the same way that the original versions were or would have been resolved.

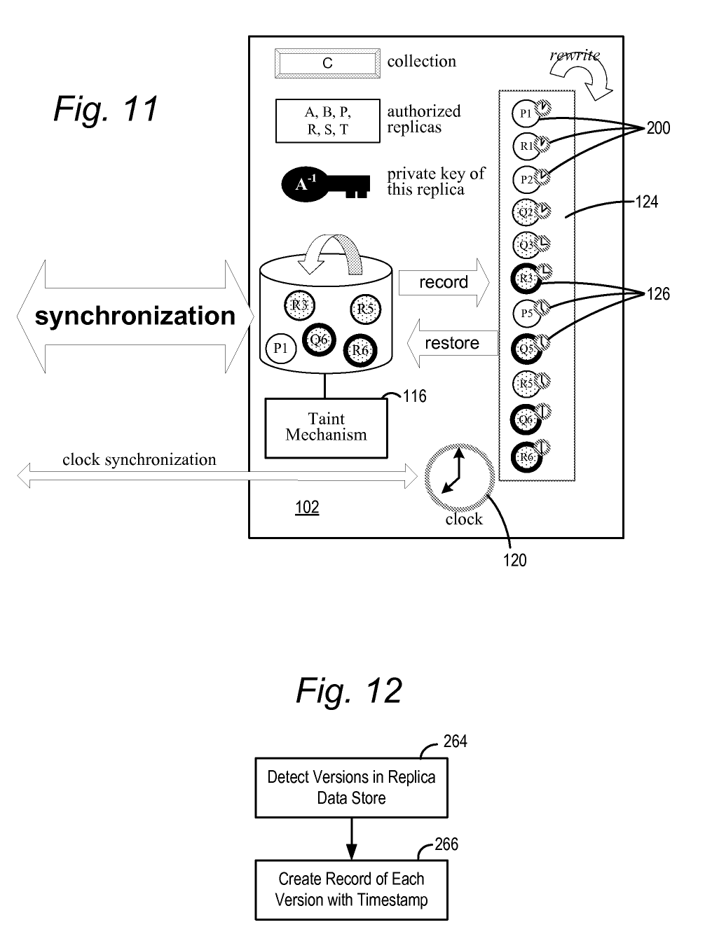

FIG. 11 shows the components of an archival replica 102. Where multiple archival replicas exist, each may have the following configuration and operation. The illustrated situation shows an archival replica A having versions resulting from the example timeline shown in FIG. 8. It is assumed that archival replica A has learned about all the versions created in the example timeline through synchronization. The archival replica A contains a clock 120 that indicates the current time and a time-stamped archive 124 that records versions seen by the archival replica.

Archival replica A further includes a recording mechanism 130, which may be software instructions executable by a processor associated with one or more archrival replicas for recording versions from the store into the archive. The archival replica A may also include a recovery mechanism 132, which may be software instructions executable by a processor associated with one or more archival replicas for performing a rewrite process to remove the taint from innocent versions and a restore process that restores discarded versions from the archive to the store. The record, rewrite and restore processes are explained hereinafter.

The clock 120 shows the current time. As indicated above, the collection manager 104 also includes a clock. A known clock synchronization process keeps all such clocks synchronized to the same time within some error bound, b. Keeping all the clocks synchronized enables the collection manager to know that a timestamp t generated by any archival replica corresponds to a time no later than t+b as indicated by the collection manager's clock. In an embodiment, the clock synchronization process may be implemented by requiring each clock to regularly set its time from some given standard time source. The interval between settings is made short enough to prevent the clock from drifting more than, for example, ½b away from the standard time source. Other methods are known to those skilled in the art.

As indicated above, the actions of the taint mechanism may result in an excessive taint situation where versions are removed from data stores even though they are innocent; that is, they contain authentic information because the influence from the compromised replica dates from before the time the replica was compromised. Embodiments of the present system recognize innocent versions and restore them to the collection. However, there is a difficulty. Innocent versions are tainted and may not simply be returned into the collection, because the taint mechanism 116 does not permit tainted versions to enter the data store. Therefore, in embodiments, in addition to or instead of the replicas having a clock synchronization process with each other, the replicas may also have a clock synchronization process with some global time indicator.

The record process will now be explained with reference to FIG. 11 and the flowchart of FIG. 12. In step 264, a processor looks for versions in the store at a given time. For each version found at the given time, a record 126 is created in the archive 124 in step 266, each including the then current time stamp indicated by the replica's clock 120. The record process may be invoked whenever a new version appears in the store. Alternatively, the record process may occur every preset time period. It is permitted for multiple records of the same version to appear in the archive. Such a situation may in fact occur because of timing delays in the interactions of multiple archival replicas. And, because of the actions of the unauthorized user, it may not even be the case that all records of the same version record the same content. Thus, multiple records of the same version may exist, each record with a different timestamp. However, as will be explained in the restore process, for any given version, only the record with the oldest timestamp is relevant. Therefore, in embodiments, the record process may not be invoked for a version that is already recorded in the archive. In such an embodiment, the processor may check whether a version already exists in the archive prior to creating a record for it. If the version already exists, no new record is recreated.

As indicated above, the actions of the taint mechanism may result in an excessive taint situation where versions are removed from data stores even though they can be recognized as containing authentic information. Embodiments of the present system recover those innocent versions to the collection. However, in embodiments, the innocent but tainted versions may not simply be returned into the collection, because the taint mechanism 116 does not permit tainted versions to enter the data store. Therefore, the present system employs a rewrite process where versions known to contain authentic information are rewritten to remove the taint, whereupon they can be recovered into the collection.

As described above with respect to step 236, FIG. 7, after the collection manager revokes a replica private key, it may then create and authorize a new key to replace the compromised key. This new key represents a virtual replica that will be used to replace the compromised replica. “Virtual” because it is a key (public-private key pair, when public key encryption is used), but, in embodiments, there is no physical device that uses this key to identify itself as a replica, especially regarding the usual functions of a replica of storing, updating, and synchronizing versions. However, in alternative embodiments, the new key pair could be associated with either a virtual replica (where archival replicas use the key to rewrite previous versions before destroying the key) or a replacement replica (that continues to use the key for new versions once the rewrite process has completed).

In step 238, FIG. 7, the collection manager next sends an indication to the archival replicas 102 to rewrite innocent versions from the compromised replica to the virtual replica. Since the collection manager created the virtual replica, it has the corresponding private key. An archival replica needs the private key in order to perform the rewrite process. The collection manager therefore communicates the newly created private key to the archival replica.

The revocation, the authorization, and the rewrite instructions from the collection manager need not be communicated in secret. They do need to be authentic, which can be accomplished via a signature as is known to those skilled in the art. The newly created private key must be communicated in secret. How to do this would also be known to those skilled in the art.

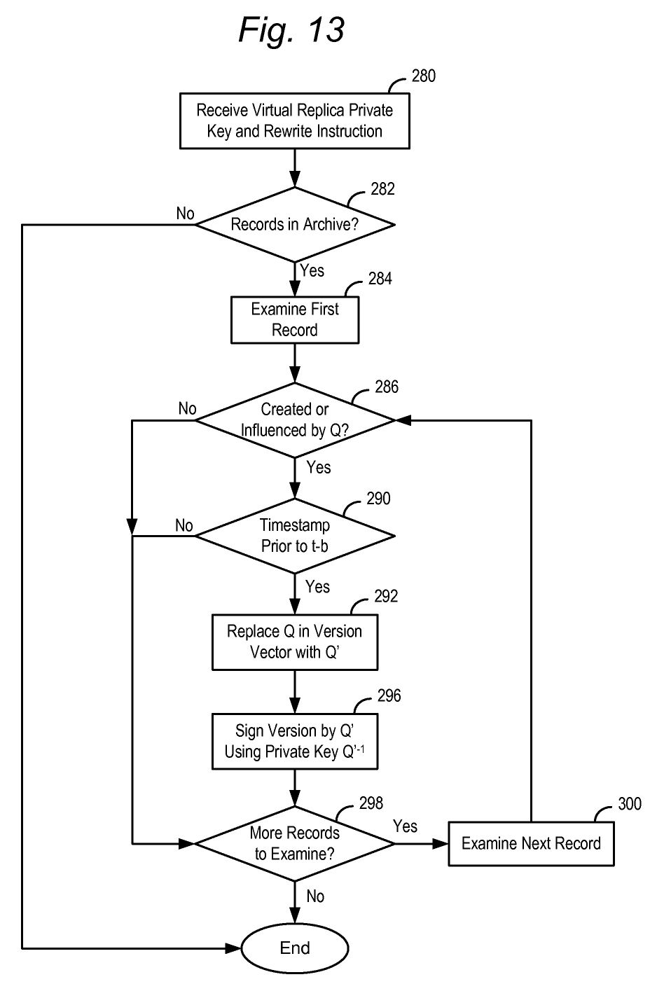

The rewrite process will now be described with reference to the flowchart of FIG. 13. In this example, it is assumed that, upon revoking a compromised replica Q, the collection manager created a virtual replica Q′ so that innocent versions from tainted version Q may be rewritten to Q′ without the taint. The rewrite process is explained with reference to archival replica A, but the process may apply to any archival replica in the collection. In step 280, the archival replica A receives the private key Q′⁻¹ for the virtual replica Q′ and the rewrite instruction. If there are no records in the archive in step 282, the rewrite process ends. Otherwise the first record is examined in step 284.

In step 286, the rewrite process examines whether the record was influenced by Q. If it was not, it is pristine and there is no need to rewrite it. If it was influenced by Q (and is hence tainted), the process next checks in step 290 whether the time stamp of the record is earlier than the timestamp of the compromise communicated from the collection manager minus the error bound, b.

In particular, as indicated above, there is a potential differential error bound, b, between the collection manager and archival replica clocks. In order to ensure that only versions from before the compromise identified by the collection manager clock are rewritten by the archival replicas, the time forwarded by the collection manager is the timestamp, t, of the compromise measured by the collection manager minus the error bound, b. This time of the compromise received by the collection manager is earlier than the measured time, t, by the error bound, b, in order to account for any time mismatch between the collection manager and the archival replica clocks. Other methods of compensating for time mismatch will be obvious to those skilled in the art.

If the record has a time stamp that is prior to t−b, the rewrite process revises the version vector to replace Q with Q′ in step 292. In embodiments, this may be accomplished by replacing Q with Q′ in the version vector of the record being examined. As the version vector for Q′ no longer reflects influence by the revoked replica Q, the rewritten version Q′ is not tainted.

On the other hand, if in step 290 the record has a time stamp that is the same as or subsequent to t−b, then the rewrite process does not rewrite the version. The rewrite process may simply leave the record as it is in the replica archive; since the version is tainted and bogus, the restore process will not restore it to the data store. Alternatively, the rewrite process may expunge the record for a tainted bogus version from the archive.

In step 296, the rewrite process then signs the rewritten version by Q′, using the private key communicated in secret from the collection manager. The time stamp is not changed. In embodiments, the signing of the rewritten versions may be performed as spare time permits or on demand when the restore process desires to insert the rewritten version into the store. Such optimizations fall within the scope of this system. In step 298, the rewrite process checks whether there are additional records. If so, the next record is examined in step 300 and the process returns to step 286 to determine whether the record was influenced by compromised replica Q.

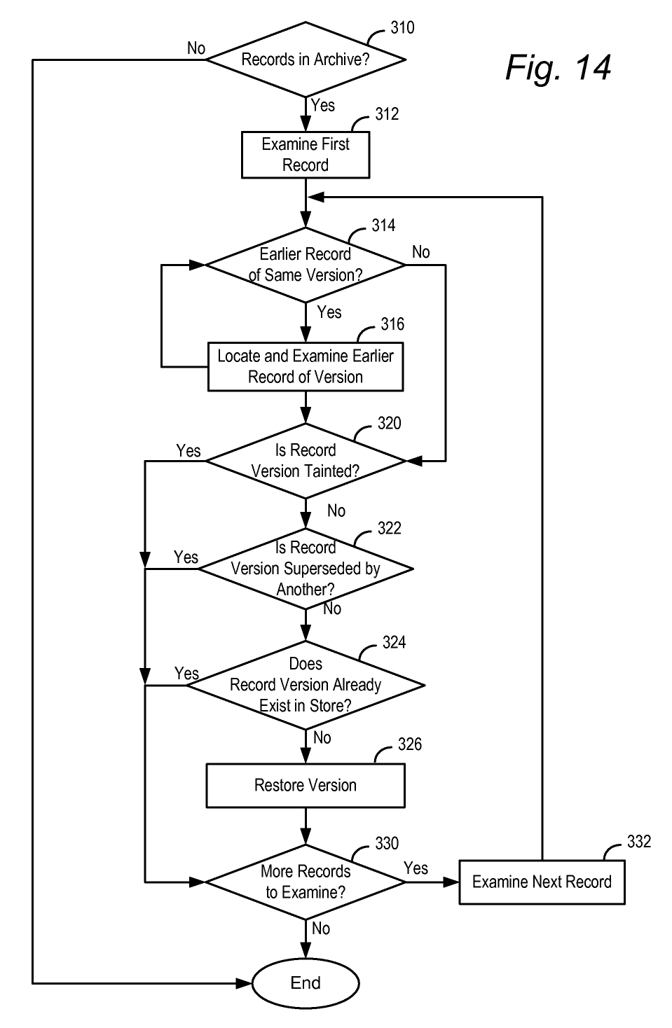

The archival replicas 102 further perform a restore process, described with reference to the flowchart of FIG. 14. If there are no records in the archive in step 310, the restore process ends. Otherwise, the first record is examined in step 312. If the restore process observes a version in the archive, the restore process may check whether there is a record of that version with an oldest timestamp in steps 314 and 316. As discussed above, it is possible that multiple records of the same version may exist, not all including the same contents (as in the case where an unauthorized user has created a bogus version). In embodiments, the restore process only considers the oldest time-stamped record for any given version. However, if the record process (FIG. 12) does not record additional time-stamped records for versions that are already in the archive, then, as is obvious to those skilled in the art, the restore process does not need to consider the situation.

Preferably, the restore process does not attempt to restore a tainted version. Accordingly, in step 320, the restore process checks whether the record being considered is tainted. For innocent versions that were originally tainted, the rewrite process described above may have rewritten the record to remove the taint. However, if the record is tainted, it is pointless to attempt to restore it, because the taint mechanism will not permit it to enter the store.

Preferably, the restore process does not restore a first version that is superseded by a second version already in the store, because the normal replica processes, which discard superseded versions, would discard the first version. Accordingly, if a record is not tainted, it is next checked in step 322 whether the record is superseded by another version in the store. If it is superseded, it is not restored. In alternative embodiments, it may be restored and simply expunged by the sync process.

Also, preferably, the restore process does not restore a first untainted version that is superseded by a second untainted version recorded in the archive, because eventually the second untainted version would be restored and then the normal replica processes, which discard superseded versions, would discard the first version. Preferably, the restore process accomplishes this by processing the records in the archive in reverse time order from most recent to least recent. Alternatively, the restore process may create a plan of work anticipating the records to be restored and then optimize this plan prior to restoring records.

If a record is not tainted or superseded, it is next checked in step 324 whether that same version exists in the store. In particular, pristine versions that exist in the store need not be replaced by their corresponding record from the archive. Though again, in embodiments, the same version may be replaced by its record.

If a record is not tainted, superseded or a duplicate, the record may be restored to the data store in step 326. In step 330, the restore process checks whether there are additional records. If so, the next record is examined in step 332 and the process returns to step 314 to determine whether there is an earlier record of the examined record. Through the above-described processes, innocent versions may be returned to the collection. The unauthorized user cannot corrupt the above-described recovery process, because an archive only recovers innocent versions that it itself saw prior to the compromise.

In embodiments, the restore process may be invoked whenever the set of authorized replicas changes or whenever some records have been rewritten. In alternative embodiments, the restore process may be invoked after passage of a preset time period. In either of these embodiments, once a record has been considered, the restore process does not need to consider it again until the set of authorized replicas changes or the record is rewritten.

If there are multiple archival replicas, preferably the collection manager communicates the same rewrite instructions to all of the archival replicas. Any rewritten innocent versions that are rewritten and restored will contain exactly the same version vectors as the original innocent versions, except that Q will everywhere be replaced with Q′. Hence, as the synchronization process spreads these rewritten and restored versions around, the decisions about which versions supersede which other versions will be made in exactly the same way as they would have been made with the original versions. It is not necessary that every archival replica have every, or even the same, original versions in its archive. No coordination between archives is needed other than the ordinary synchronization process.

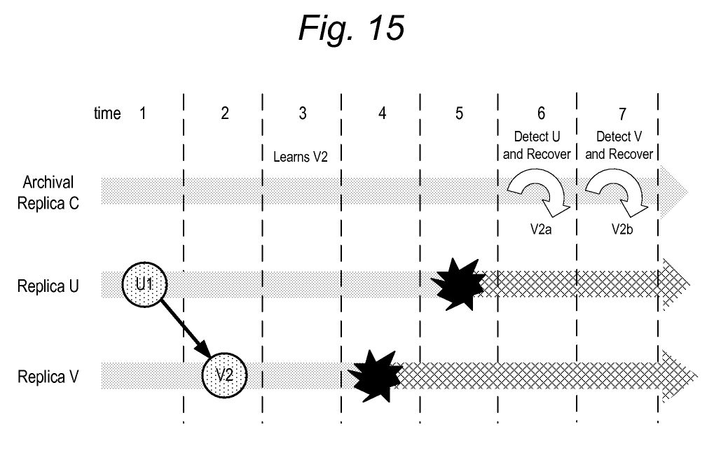

In embodiments, the rewrite process does not change the time stamp on a rewritten record. This preserves the knowledge in the archive that the record actually dates from an older time, when the original version was first seen. In this way, even if multiple compromises occur, the original version can still be recovered provided it is innocent of all the compromises. For example, FIG. 15 shows a time line where, at time 1, replica U creates version U1, which replica V learns and then at time 2 updates to version V2. At time 3, archival replica C learns V2, and records it in the archive.

Later, at time 6, the detection mechanism announces that replica U was compromised at time 5. The collection manager revokes U which taints version V2. The collection manager creates a virtual replica U′ to replace the compromised replica U, and issues a rewrite instruction to rewrite U as U′ prior to time 5. This causes the archival replica C to restore a rewritten version of V2, arbitrarily referred to here as V2a.

Later, at time 7, the detection mechanism announces that replica V was compromised at time 4. The collection manager revokes V which taints version V2a. The collection manager creates a virtual replica V′ to replace compromised replica V, and issues a rewrite instruction to rewrite V as V′ prior to time 4. Because the archival replica C has maintained the original timestamp of 3 on its rewritten version V2a, it knows that V2a is innocent of the new compromise, so it rewrites V2a to V2b and restores it.

If the detection mechanism had announced that replica V was compromised at time 3, the archived record of V2a would not be old enough to prove its innocence. In that case, the archive would restore a rewritten version of U1.

FIG. 16 illustrates an example of a suitable general computing system environment 400 for implementing a replica, archival replica and/or collection manager. It is understood that the term “computer” as used herein broadly applies to any digital or computing device or system. The computing system environment 400 is only one example of a suitable computing environment and is not intended to suggest any limitation as to the scope of use or functionality of the inventive system. Neither should the computing system environment 400 be interpreted as having any dependency or requirement relating to any one or combination of components illustrated in the exemplary computing system environment 400.

The inventive system is operational with numerous other general purpose or special purpose computing systems, environments or configurations. Examples of well known computing systems, environments and/or configurations that may be suitable for use with the inventive system include, but are not limited to, personal computers, server computers, multiprocessor systems, microprocessor-based systems, set top boxes, programmable consumer electronics, network PCs, minicomputers, mainframe computers, laptop and palm computers, hand held devices, distributed computing environments that include any of the above systems or devices, and the like.

With reference to FIG. 16, an exemplary system for implementing the inventive system includes a general purpose computing device in the form of a computer 410. Components of computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 410 may include a variety of computer readable media. Computer readable media can be any available media that can be accessed by computer 410 and includes both volatile and nonvolatile media, removable and non-removable media. By way of example, and not limitation, computer readable media may comprise computer storage media and communication media. Computer storage media includes volatile and nonvolatile, as well as removable and non-removable media implemented in any method or technology for storage of information such as computer readable instructions, data structures, program modules or other data. Computer storage media includes, but is not limited to, random access memory (RAM), read only memory (ROM), EEPROM, flash memory or other memory technology, CD-ROMs, digital versatile discs (DVDs) or other optical disc storage, magnetic cassettes, magnetic tapes, magnetic disc storage or other magnetic storage devices, or any other medium which can be used to store the desired information and which can be accessed by computer 410. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 430 includes computer storage media in the form of volatile and/or nonvolatile memory such as ROM 431 and RAM 432. A basic input/output system (BIOS) 433, containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 16 illustrates operating system 434, application programs 435, other program modules 436, and program data 437.

The computer 410 may also include other removable/non-removable, volatile/nonvolatile computer storage media. By way of example only, FIG. 16 illustrates a hard disc drive 441 that reads from or writes to non-removable, nonvolatile magnetic media and a magnetic disc drive 451 that reads from or writes to a removable, nonvolatile magnetic disc 452. Computer 410 may further include an optical media reading device 455 to read and/or write to an optical media.

Other removable/non-removable, volatile/nonvolatile computer storage media that can be used in the exemplary operating environment include, but are not limited to, magnetic tape cassettes, flash memory cards, DVDs, digital video tapes, solid state RAM, solid state ROM, and the like. The hard disc drive 441 is typically connected to the system bus 421 through a non-removable memory interface such as interface 440. Magnetic disc drive 451 and optical media reading device 455 are typically connected to the system bus 421 by a removable memory interface, such as interface 450.

The drives and their associated computer storage media discussed above and illustrated in FIG. 16, provide storage of computer readable instructions, data structures, program modules and other data for the computer 410. In FIG. 16, for example, hard disc drive 441 is illustrated as storing operating system 444, application programs 445, other program modules 446, and program data 447. These components can either be the same as or different from operating system 434, application programs 435, other program modules 436, and program data 437. Operating system 444, application programs 445, other program modules 446, and program data 447 are given different numbers here to illustrate that, at a minimum, they are different copies. A user may enter commands and information into the computer 410 through input devices such as a keyboard 462 and a pointing device 461, commonly referred to as a mouse, trackball or touch pad. Other input devices (not shown) may include a microphone, joystick, game pad, satellite dish, scanner, or the like. These and other input devices are often connected to the processing unit 420 through a user input interface 460 that is coupled to the system bus 421, but may be connected by other interface and bus structures, such as a parallel port, game port or a universal serial bus (USB). A monitor 491 or other type of display device is also connected to the system bus 421 via an interface, such as a video interface 490. In addition to the monitor, computers may also include other peripheral output devices such as speakers 497 and printer 496, which may be connected through an output peripheral interface 495.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 16. The logical connections depicted in FIG. 16 include a local area network (LAN) 471 and a wide area network (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communication over the WAN 473, such as the Internet. The modem 472, which may be internal or external, may be connected to the system bus 421 via the user input interface 460, or other appropriate mechanism. In a networked environment, program modules depicted relative to the computer 410, or portions thereof, may be stored in the remote memory storage device. By way of example, and not limitation, FIG. 16 illustrates remote application programs 485 as residing on memory device 481. It will be appreciated that the network connections shown are exemplary and other means of establishing a communication link between the computers may be used.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

We claim:

1. A computer implemented method of recovering from a compromise of a replica in a weakly-consistent distributed collection, the method comprising the steps of:
(a) identifying versions of objects in the collection in a replica data store of the collection created by the compromised replica;
(b) identifying versions in the replica data store of the collection that were influenced by the compromised replica; and
(c) expunging the versions from the replica data store identified in said step (a) and said step (b).

2. A computer implemented method as recited in claim 1, wherein said step (a) and (b) comprise the step of checking an influence list, stored in association with respective versions in the collection, the influence list indicating creation or update by replicas in the collection.

3. A computer implemented method as recited in claim 1, further comprising the step (d) of receiving an indication of a time of the compromise.

4. A computer implemented method as recited in claim 3, further comprising the step (e) of recovering a version expunged in said step (c) where the version was influenced by the compromised replica prior to the time of the compromise indicated in said step (d).

5. A computer implemented method as recited in claim 4, wherein said step (e) of recovering an expunged version comprises the steps:
(e1) rewriting an historical record of the expunged version to remove reference to the compromised version; and
(e2) restoring the record of the expunged version to the data store.

6. A computer implemented method of recovering from a compromise of a replica indicated to have occurred at a time t in a weakly-consistent distributed collection, the method comprising the steps of:
(a) expunging all versions that were tainted by the compromised replica from a data store of a replica; and
(b) restoring a version that was expunged in said step (a) to the data store where the expunged version was not influenced by the compromised replica at or after time t.

7. A computer implemented method as recited in claim 6, further comprising the step (c) of storing an archival record of versions received within a replica at a time prior to time t.

8. A computer implemented method as recited in claim 7, further comprising the step (d) of maintaining an historical record in association with the expunged version of which replicas created and/or updated the version.

9. A computer implemented method as recited in claim 7, said step (b) of restoring the expunged version to the data store comprises the step of:
(b1) retrieving the archival record of the expunged version stored in said step (c);
(b2) rewriting the historical record associated with the archival record of the expunged version to remove reference to the compromised replica; and
(b3) restoring the archival record of the expunged version to the data store.

10. A computer implemented method as recited in claim 7, further comprising the step (e) of restoring a version to the data store that was discarded from the data store after being superseded by a tainted version.

11. A computer implemented method as recited in claim 10, said step (e) of restoring a discarded version comprising the steps of:
(e1) retrieving the archival record of the discarded version stored in said step (c); and
(e2) restoring the archival record of the discarded version to the data store.

12. A computer implemented method as recited in claim 10, said step (e) of restoring a discarded version comprising the steps of:
(e1) retrieving the archival record of the discarded version stored in said step (c);
(e2) determining whether the discarded version in the archival record was influenced by the compromised replica at a time t or later, and
(e3) restoring the archival record of the discarded version to the data store if it is determined in said step (e2) that the discarded version was not influenced by the compromised replica at a time t or later.

13. A computer implemented method as recited in claim 12, further comprising the steps of:
(e4) determining whether the discarded version is superseded by a version existing in the data store after said step (a) of expunging tainted versions from the data store, and
(e5) restoring the archival record of the discarded version to the data store if it is determined in said step (e2) that the discarded version was not influenced by the compromised replica at a time t or later, and if it is determined in said step (e4) that the discarded version is not superseded by a version existing in the data store after said step (a) of expunging tainted versions from the data store.

14. A system for recovering from a compromise of a replica of a plurality of replicas in a weakly-consistent distributed collection, comprising:
a collection manager for establishing authorization policy to control sharing of versions between the plurality of replicas; and
an archival replica in the plurality of replicas, the archival replica including a data store and an archive of versions admitted into the data store together with a time stamp of when the versions were admitted to the data store.

15. A system as recited in claim 14, wherein upon an update of a version by a replica of the plurality of replicas, the updating replica signs the update using cryptography for other replicas to validate the signature of the updating replica.

16. A system as recited in claim 15, wherein the collection manager issues policy via cryptographically signed statements.

17. A system as recited in claim 14, further comprising a taint mechanism for expunging versions from one or more of the plurality of replicas determined by the taint mechanism to have been influenced by the compromised replica at or after the indicated time of the compromise.

18. A system as recited in claim 14, further comprising a recovery mechanism for recovering versions from the archive into the data store after ensuring that the versions were not influenced by the compromised replica at or after the indicated time of the compromise.

19. A system as recited in claim 18, wherein the collection manager is further capable of generating a replica authorized to replace a compromised replica that is revoked.

20. A system as recited in claim 19, wherein the recovery mechanism is capable of rewriting an influence list associated with tainted versions to replace a reference in the influence list to the compromised replica with a reference to the replica generated by the collection manager to replace the compromised replica.
